(19) United States
(12) Patent Application Publication
(10) Pub. No.: US 2006/0023716 A1
(43) Pub. Date: Feb. 2, 2006

(54) Bit bucket

(75) Inventors: Jenny Liu Fischer, Mountain View, CA (US); Autumn Jane Niu, Sunnyvale, CA (US)

Correspondence Address: MCDERMOTT WILL & EMERY LLP, 600 13TH STREET, N.W., WASHINGTON, DC, 20005-3096, US

(73) Assignee: ADVANCED MICRO DEVICES, INC., Sunnyvale, CA (US)

(21) Appl. No.: 11/236,670

(22) Filed: Sep. 28, 2005

Related U.S. Application Data
(63) Continuation of application No. 09/314,969, filed on May 20, 1999.

(51) Int. Cl. H04L 12/56

(52) U.S. Cl. 370/389

(57) ABSTRACT

A multiport data communication system for switching data packets between ports comprises a plurality of ports for receiving and transmitting data packets, a memory temporarily storing the data packets received at the switch. Each port has a transmit queue queuing data packets from the memory, an output terminal outputting the data packets, and a data path connecting the transmit queue and the output terminal. The data path has a gate controlling transferring of data packets in the data path to the output terminal. The data packets are frame data and all data in each respective transmit queue is transferred to the data path regardless of the assertion or deassertion of the enable signal. The enable signal controls the gate to either transfer an entire frame on the data path to the output terminal or block transfer of the entire frame to the output terminal. At the same time, the transmit queue is emptied, whether or not the frame is blocked or transferred.

### FIELD OF THE INVENTION

This invention relates to data communication systems, and more particularly, to a method and mechanism for blocking data in a data path from being output to a media access control (MAC) while draining the data from the data path.

### BACKGROUND ART

A data communication network, such as a Local Area Network (LAN), uses a network cable or other network media to link nodes (e.g., workstations, routers and switches) to the data communication network. A LAN architecture uses a media access control (MAC) enabling a Media Independent Interface (MII) in order to share access to the media. A multiport communication switch may be provided in the data communication network to enable data communication between multiple network stations connected to various ports of the switch. A logical connection may be created between ports of the switch to forward received data packets, e.g., frame data, to appropriate destinations. Based on frame headers, a frame forwarding arrangement selectively transfers received frame data (packet data) to a destination station. The multiport communication switch includes a MAC to provide digital packet data to Physical (PHY) layer devices configured for translating the digital packet data received from the MAC across the MII, into an analog signal for transmission on the network medium, and reception of analog signals transmitted from a remote node via the network medium.

Frame data received at a port of the communication switch may be transferred to an external memory and subsequently retrieved and placed in a transmit queue (FIFO) for transmission from one or more respective ports of the switch. Occasionally, errors are encountered while the frame data is being output from the transmit FIFO to a media access control (MAC) data path connected to a media independent interface (MII) (e.g., loss of carrier (no transmission link)), which prevent the data from being output to the MII. In such case, there is a need to provide a mechanism and method for blocking the data in the MAC data path from being output to the MII and drain (discharge) the data from the MAC data path.

### DISCLOSURE OF THE INVENTION

The invention provides a novel arrangement for blocking data on a data path connected to a transmit FIFO from being output to the network. The apparatus includes a multiport data communication system for switching data packets between ports and comprises a plurality of receive ports tor receiving data packets, a memory storing the received data packets, and a plurality of transmit ports for transmitting data packets. Each transmit port includes a transmit queue queuing data packets from the memory, an output terminal outputting the data packets, and a data path connecting the transmit queue and the output terminal, the data path having a gate controlling transferring of data packets in the data path to the output terminal.

In one aspect of the invention, the data packets comprise frame data and the gate is responsive to assertion of an enable signal to transfer an entire frame to the output terminal and to deassertion- of the enable signal to block the entire frame from being transferred to the output terminal.

The invention provides also a novel method of controlling transmission of received data packets from at least one of a plurality of transmit ports and comprises receiving data packets via a plurality of receive ports, storing the received data packets in a memory, reading data from the memory corresponding to each data packet to be transmitted from a respective transmit port and storing in a transmit queue for the respective transmit port. Each data packet is transferred from the transmit queue to a data path connected between the transmit queue and an output terminal, and in response to assertion and deassertion of an enable signal, data packets in the data path are transferred to the output terminal or block therefrom.

In one aspect of the method, the data packets comprise frame data and each data in each respective transmit queue is transferred to the data path regardless of the assertion or deassertion of the enable signal. The enable signal controls an AND gate for one of transferring an entire frame on the data path to the output terminal and blocking transferring the entire frame to the output terminal.

Various objects and features of the present invention will become more readily apparent to those skilled in the art from the following description of a specific embodiment thereof, especially when taken in conjunction with the accompanying drawings.

### BRIEF DESCRIPTION OF THE DRAWINGS

FIG. 1 is a block diagram of a packet switched network including a multiple port switch according to an embodiment of the present invention.

FIG. 2 is a block diagram of the multiple port switch of FIG. 1.

FIG. 3 is a block diagram illustrating in detail the switching subsystem of FIG. 2.

FIG. 4 is a diagram showing an exemplary data path according to an embodiment of the present invention.

### BEST MODE FOR CARRYING OUT THE INVENTION

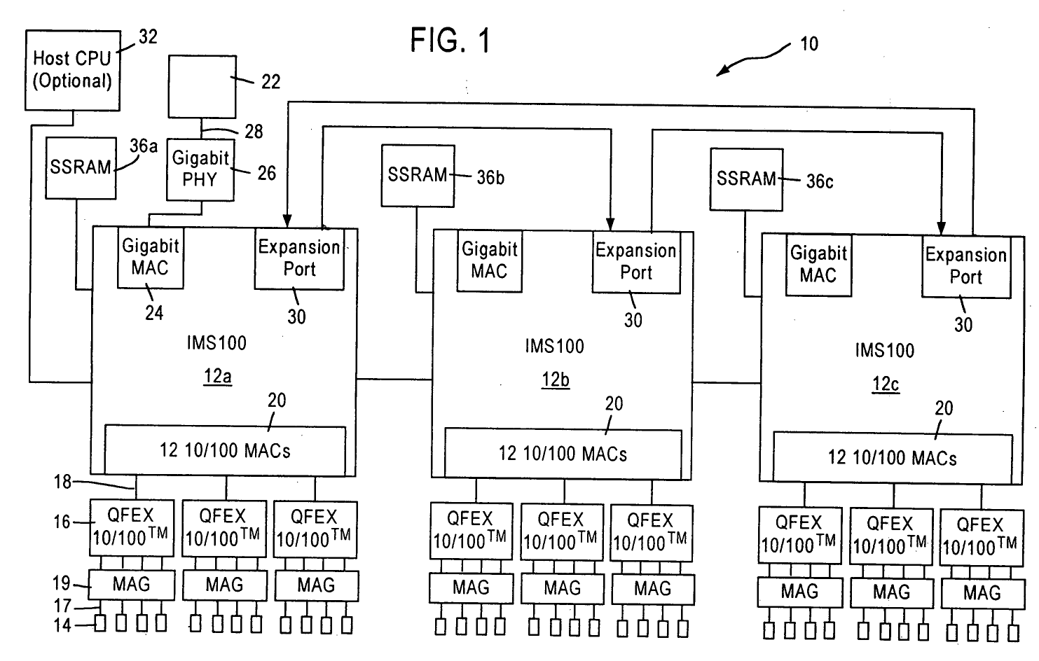

FIG. 1 is a block diagram of an exemplary system in which the present invention may be advantageously employed. The exemplary system 10 is a packet switched network, such as an Ethernet (IEEE 802.3) network. The packet switched network includes integrated multiport switches (IMS) 12 (12a-12c) that enable communication of data packets between network stations. The network may include network stations having different configurations, for example twelve (12) 10 megabit per second (Mb/s) or 100 Mb/s network stations 14 (hereinafter 10/100 Mb/s) that send and receive data at a network data rate of 10 Mb/s or 100 Mb/s, and a 1000 Mb/s (i.e., 1 Gb/s) network node 22 that sends and receives data packets at a network speed of 1 Gb/s. The gigabit node 22 may be a server, or a gateway to a high-speed backbone network. Hence, the multiport switches 12 selectively forward data packets received from the network nodes 14 or 22 to the appropriate destination based upon Ethernet protocol.

Each multiport switch 12 includes a media access control (MAC) module 20 that transmits and receives data packets to and from 10/100 Mb/s physical layer (PHY) transceivers 16 via respective reduced media independent interfaces (RMII) 18 according to IEEE 802.3u protocol. Each multiport switch 12 also includes a gigabit MAC 24 for sending and receiving data packets to and from a gigabit PHY 26 for transmission to the gigabit node 22 via a high speed network medium 28.

Each 10/100 Mb/s network station 14 sends and receives data packets to and from the corresponding multiport switch 12 via a media 17 and according to either half-duplex or full duplex Ethernet protocol. The Ethernet protocol ISO/IEC 8802-3 (ANSI/IEEE Std. 802.3, 1993 Ed.) defines a half-duplex media access mechanism that permits all stations 14 to access the network channel with equality. Traffic in a half-duplex environment is not distinguished over the medium 17. Rather, each half-duplex station 14 includes an Ethernet interface card that uses carrier-sense multiple access with collision detection (CSMA/CD) to listen for traffic on the media. The absence of network traffic is detected by sensing a deassertion of a receive carrier on the media. Any station 14 having data to send will attempt to access the channel by waiting a predetermined time, known as the interpacket gap interval (IPG), after the deassertion of a receive carrier on the media. If a plurality of stations 14 have data to send on the network, each of the stations will attempt to transmit in response to the sensed deassertion of the receive carrier on the media and after the IPG interval, resulting in a collision. Hence, the transmitting station will monitor the media to determine if there has been a collision due to another station sending data at the same time. If a collision is detected, both stations stop, wait a random amount of time, and retry transmission.

The 10/100 Mb/s network stations 14 that operate in full duplex mode send and receive data packets according to the Ethernet standard IEEE 802.3u. The full-duplex environment provides a two-way, point-to-point communication link enabling simultaneous transmission and reception of data packets between each link partner, i.e., the 10/100 Mb/s network station 14 and the corresponding multiport switch 12.

Each multiport switch 12 is coupled to 10/100 PHY transceivers 16 configured for sending and receiving data packets to and from the corresponding multiport switch 12 across a corresponding reduced media independent interface (RMII) 18. In particular, each 10/100 PHY transceiver 16 is configured for sending and receiving data packets between the multiport switch 12 and up to four (4) network stations 14 via the shared RMII 18. A magnetic transformer 19 provides AC coupling between the PHY transceiver 16 and the corresponding network medium 17. Hence, the shared RMII 18 operates at a data rate sufficient to enable simultaneous, transmission and reception of data packets by each of the network stations 14 to the corresponding PHY transceiver 16.

Each multiport switch 12 also includes an expansion port 30 for transferring data between other switches according to a prescribed protocol. Each expansion port 30 enables multiple multiport switches 12 to be cascaded together as a separate backbone network.

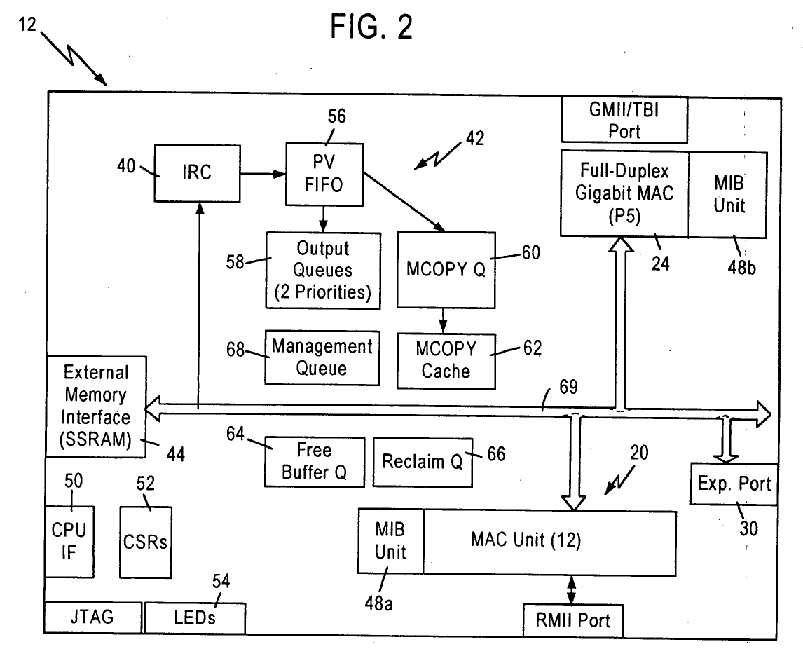

FIG. 2 is a block diagram of the multiport switch 12. The multiport switch 12 contains a decision making engine 40 that performs frame forwarding decisions, a switching subsystem 42 for transferring frame data according to the frame forwarding decisions, an external memory interface 44, management information base (MIB) counters 48a and 48b (collectively 48), and MAC (media access control) protocol interfaces 20 and 24 to support the routing of data packets between the Ethernet (IEEE 802.3) ports serving the network stations 14 and the gigabit mode 22. The MIB counters 48 provide statistical network information in the form of management information base (MIB) objects to an external management entity controlled by a host CPU 32, described below.

The external memory interface 44 enables external storage of packet data in an external memory 36 such as, for example, a synchronous static random access memory (SSRAM), in order to minimize the chip size of the multiport switch 12. In particular, the multiport switch 12 uses the memory 36 for storage of received frame data and memory structures. The memory 36 is preferably either a Joint Electron Device Engineering Council (JEDEC) pipelined burst or Zero Bus Turnaround™ (ZBT)-SSRAM having a 64-bit wide data path and a 17-bit wide address path. The External Memory 36 is addressable as upper and lower banks of 128K in 64-bit words. The size off the external memory 36 is preferably at least 1 Mbytes, with data transfers possible on every clock cycle through pipelining. Additionally, the external memory interface clock operates at clock frequencies of at least 66 MHz, and, preferably, 100 MHz and above.

The multiport switch 12 also includes a processing interface 50 that enables an external management entity such as a host CPU 32 to control overall operations of the multiport switch 12. In particular, the processing interface 50 decodes CPU accesses within a prescribed register access space, and reads and writes configuration and status values to and from configuration and status registers 52.

The internal decision making engine 40, referred to as an internal rules checker (IRC), makes frame forwarding decisions for data packets received.

The multiport switch 12 also includes an LED interface 54 that clocks out the status of conditions per port and drives external LED logic. The external LED logic drives LED display elements that are humanly readable.

The switching subsystem 42, configured for implementing the frame forwarding decisions of the IRC 40, includes a port vector first in first out (FIFO) buffer 56, a plurality of output queues 58, a multicopy queue 60, a multicopy cache 62, a free buffer queue 64, and a reclaim queue 66.

The MAC unit 20 includes modules for each port, each module including a MAC receive portion, a receive FIFO buffer, a transmit FIFO buffer, and a MAC transmit portion. Data packets from a network station 14 are received by the corresponding MAC port and stored in the corresponding receive FIFO. The MAC unit 20 obtains a free buffer location (i.e., a frame pointer) from the free buffer queue 64,, and outputs the received data packet from the corresponding receive FIFO to the external memory interface 44 for storage in the external memory 36 at the location specified by the frame pointer.

The IRC 40 monitors (i.e., “snoops”) the data bus to determine the frame pointer value and the header information of the received packet (including source, destination, and VLAN address information). The IRC 40 uses header information to determine which MAC ports will output the data frame stored in the external memory 36 at the location specified by the frame pointer. The decision making engine (i.e., the IRC 40) may thus determine that a given data packet should be output by either a single port, multiple ports, all ports (i.e., broadcast), or no ports (i.e., discarded). For example, each data packet includes a header having source and destination address, where the decision making engine 40 may identify the appropriate output MAC port based upon the destination address. Alternatively, the destination address may correspond to a virtual address that the appropriate decision making engine identifies as corresponding to a plurality of network stations. In addition, the frame may include a VLAN (virtual LAN) tag header that identifies the frame information as information destined to one or more members of a prescribed group of stations. The IRC 40 may also determine that the received data packet should be transferred to another multiport switch 12 via the expansion port 30. Hence, the internal rules checker 40 will decide whether a frame temporarily stored in the memory 36 should be output to a single MAC port or multiple MAC ports.

The internal rules checker 40 outputs a forwarding decision to the switch subsystem 42 in the form of a forwarding descriptor. The forwarding descriptor includes a priority class identifying whether the frame is high priority or low priority, a port vector identifying each MAC port that should receive the data frame, Rx (received) port number, an untagged set field, VLAN information, vector identifying each MAC port that should include VLAN information during transmission, opcode, and frame pointer. The port vector identifies the MAC ports to receive the frame data for transmission (e.g., 10/100 MAC ports 1-12, Gigabit MAC port, and/or Expansion port). The port vector FIFO 56 decodes the forwarding descriptor including the port vector, and supplies the frame pointers to the appropriate output queues 58 that correspond to the output MAC ports to receive the data packet transmission. In other words, the port vector FIFO 56 supplies the frame pointer on a per-port basis. The output queues 58 give the frame pointer to a dequeuing block 76 which fetches the data frame identified in the port vector from the external memory 36 via the external memory interface 44, and supply the retrieved data frame to the appropriate transmit FIFO of the identified ports. If a data frame is to be supplied to a management agent, the frame pointer is also supplied to a management queue 68 which can be processed by the host CPU 32 via the CPU interface 50.

The multicopy queue 60 and the multicopy cache 62 keep track of the number of copies of the data frame that are transmitted from the respective ports, ensuring that the data frame is not overwritten in the external memory 36 until the appropriate number of copies of the data frame have been output from the external memory 36. Once the number of copies corresponds to the number of ports specified in the port vector FIFO 56, the frame pointer is forwarded to the reclaim queue 66. The reclaim queue stores frame pointers that can be reclaimed and walks the linked list chain to return the buffers to the free buffer queue 64 as free pointers. After being returned to the free buffer queue 64, the frame pointer is available for reuse by the MAC unit 20 or the gigabit MAC unit 24.

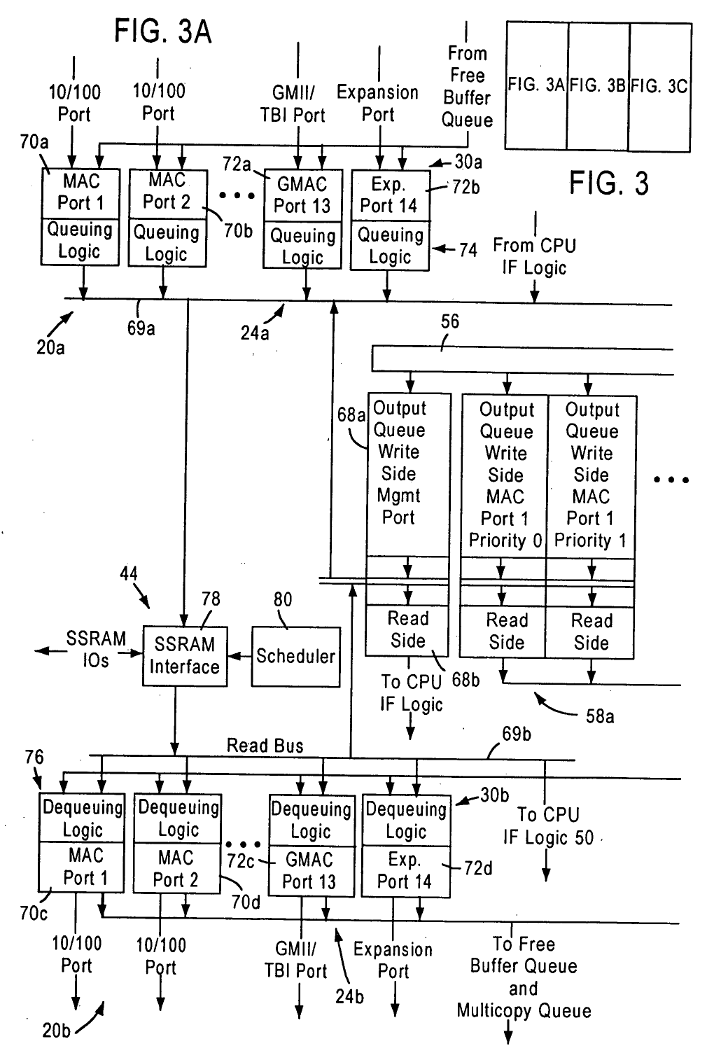

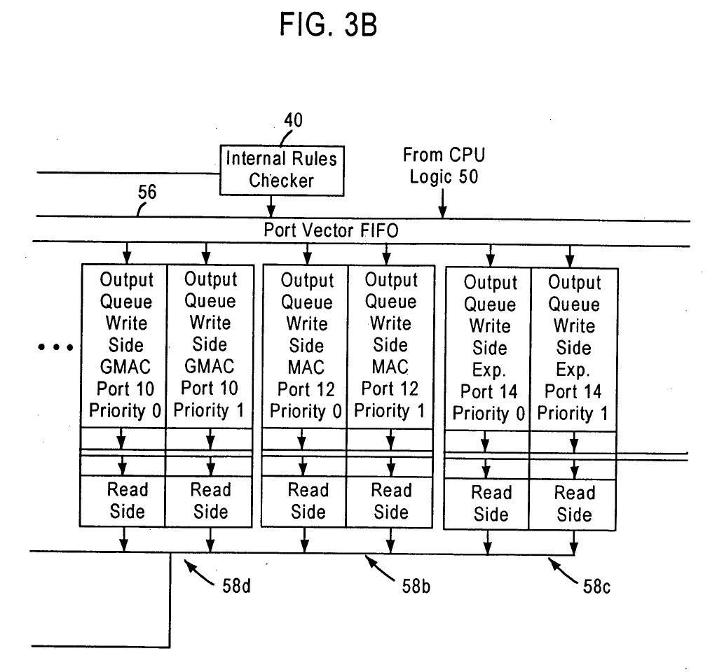

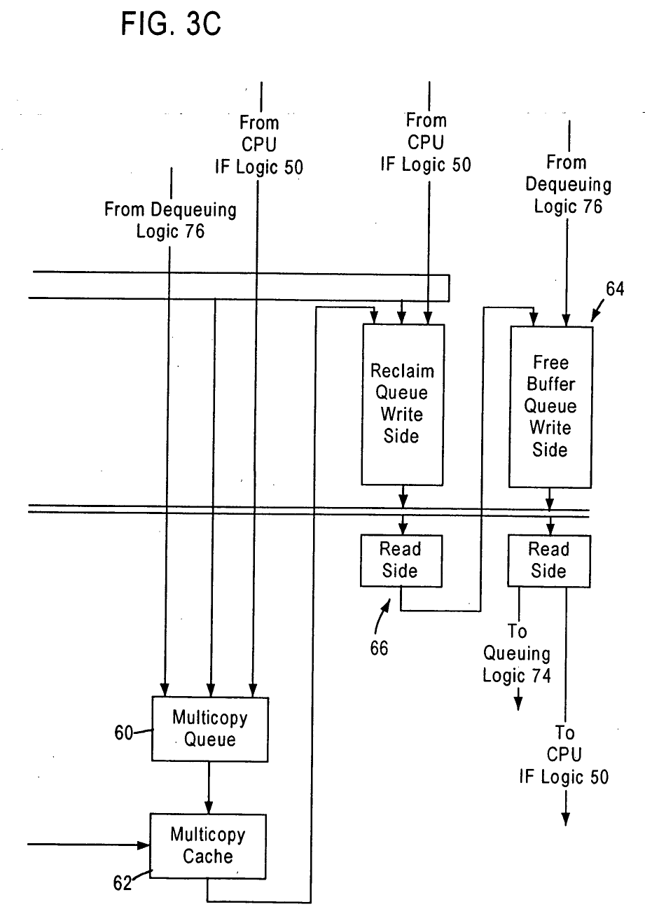

FIG. 3 depicts the switch subsystem 42 of FIG. 2 in more detail according to an exemplary embodiment of the present invention. Other elements of the multiport switch 12 of FIG. 2 are reproduced in FIG. 3 to illustrate the connections of the switch subsystem 42 to these other elements.

As shown in FIG. 3, the MAC module 20 includes a receive portion 20a and a transmit portion 20b. The receive portion 20a and the transmit portion 20b each include 12 MAC modules (only two of each shown and referenced by numerals 70a, 70b, 70c and 70d) configured for performing the corresponding receive or transmit function according to IEEE 802.3 protocol. The MAC modules 70c and 70d perform the transmit MAC operations for the 10/100 Mb/s switch ports complementary to modules 70a and 70b, respectively.

The gigabit MAC port 24 also includes a receive portion 24a and a transmit portion 24b, while the expansion port 30 similarly includes a receive portion 30a and a transmit portion 30b. The gigabit MAC port 24 and the expansion port 30 also have receive MAC modules 72a and 72b optimized for the respective ports. The transmit portions 24b and 30b of the gigabit MAC port 24 and the expansion port 30a also have transmit MAC modules 72c and 72d, respectively. The MAC modules are configured for full-duplex operation on the corresponding port, and the gigabit MAC modules 72a and 72c are configured in accordance with the Gigabit Proposed Standard IEEE Draft P802.3z.

Each of the receive MAC modules 70a, 70b, 72a, and 72b include queuing logic 74 for transfer of received data from the corresponding internal receive FIFO to the external memory 36 and the rules checker 40. Each of the transmit MAC modules 70c, 70d, 72c, and 72d includes a dequeuing logic 76 for transferring data from the external memory 36 to the corresponding internal transmit FIFO, and a queuing logic 74 for fetching frame pointers from the free buffer queue 64. The queuing logic 74 uses the fetched frame pointers to store receive data to the external memory 36 via the external memory interface controller 44. The frame buffer pointer specifies the location in the external memory 36 where the received data frame will be stored by the receive FIFO.

The external memory interface 44 includes a scheduler 80 for controlling memory access by the queuing logic 74 or dequeuing logic 76 of any switch port to the external memory 36, and an SSRAM interface 78 for performing the read and write operations with the external memory 36. In particular, the multiport switch 12 is configured to operate as a non-blocking switch, where network data is received and output from the switch ports at the respective wire rates of 10, 100, or 1000 Mb/s. Hence, the scheduler 80 controls the access by different ports to optimize usage of the bandwidth of the external memory 36.

Each receive MAC stores a portion of a frame in an internal FIFO upon reception from the corresponding switch port; the size of the FIFO is sufficient to store the frame data that arrives between scheduler time slots. The corresponding queuing logic 74 obtains a frame pointer and sends a write request to the external memory interface 44. The scheduler 80 schedules the write request with other write requests from the queuing logic 74 or any read requests from the dequeuing logic 76, and generates a grant for the requesting queuing logic 74 (or the dequeuing logic 76) to initiate a transfer at the scheduled event (i.e., slot). Sixty-four bits of frame data is then transferred over a write data bus 69a from the receive FIFO to the external memory 36 in a direct memory access (DMA) transaction during the assigned slot. The frame data is stored in the location pointed to by the free buffer pointer obtained from the buffer pool 64, although a number of other buffers may be used to store data frames, as will be described.

The rules checker 40 also receives the frame pointer and the header information (including source address, destination address, VLAN tag information, etc.) by monitoring (i.e., snooping) the DMA write transfer on the write data bus 69a. The rules checker 40 uses the header information to make the forwarding decision and generate a forwarding instruction in the form of a forwarding descriptor that includes a port vector. The port vector has a bit set for each output port to which the frame should be forwarded. If the received frame is a unicopy frame, only one bit is set in the port vector generated by the rules checker 40. The single bit that is set in the port vector corresponds to a particular one of the ports.

The rules checker 40 outputs the forwarding descriptor including the port vector and the frame pointer into the port vector FIFO 56. The port vector is examined by the port vector FIFO 56 to determine which particular output queue should receive the associated frame pointer. The port vector FIFO 56 places the frame pointer into the top of the appropriate queue 58 and/or 68. This queues the transmission of the frame.

As shown in FIG. 3, each of the transmit MAC units 70c, 70d, 72d, and 72c has an associated output queue 58a, 58b, 58c, and 58d, respectively. In preferred embodiments, each of the output queues 58 has a high priority queue for high priority frame pointers, and a low priority queue for low priority frame pointers. The high priority frame pointers are used for data frames that require a guaranteed access latency, e.g., frames for multimedia applications or management MAC frames. The frame pointers stored in the FIFO-type output queues 58 are processed by the dequeuing logic 76 for the respective transmit MAC units. At some point in time, the frame pointer reaches the bottom of an output queue 58, for example, output queue 58d for the gigabit transmit MAC 72c. The dequeuing logic 76 for the transmit gigabit port 24b takes the frame pointer from the corresponding gigabit port output queue 58d, and issues a request to the scheduler 80 to read the frame data from the external memory 36 at the memory location specified by the frame pointer. The scheduler 80 schedules the request, and issues a grant for the dequeuing logic 76 of the transmit gigabit port 24b to initiate a DMA read. In response to the grant, the dequeuing logic 76 reads the frame data (along the read bus 69b) in a DMA transaction from the location in external memory 36 pointed to by the frame pointer, and stores the frame data in the internal transmit FIFO for transmission by the transmit gigabit MAC 72c. If the forwarding descriptor specifies a unicopy transmission, the frame pointer is returned to the free buffer queue 64 following writing the frame data into the transmit FIFO.

A multicopy transmission is similar to the unicopy transmission, except that the port vector has multiple bits set, designating the multiple ports from which the data frame will be transmitted. The frame pointer is placed into each of the appropriate output queues 58 and transmitted by the appropriate transmit MAC units 20b, 24b, and/or 30b.

The free buffer pool 64, the multicopy queue 60, the reclaim queue 66, and the multicopy cache 62 are used to manage use of frame pointers and re-use of frame pointers once the data frame has been transmitted to its designated output port(s). In particular, the dequeuing logic 76 passes frame pointers for unicopy frames to the free buffer queue 64 after the buffer contents have been copied to the appropriate transmit FIFO.

For multicopy frames, the port vector FIFO 56 supplies multiple copies of the same frame pointer to more than one output queue 58, each frame pointer having a unicopy bit set to zero. The port vector FIFO 56 also copies the frame pointer and the copy count to the multicopy queue 60. The multicopy queue 60 writes the copy count to the multicopy cache 62. The multicopy cache 62 is a random access memory having a single copy count for each buffer in external memory 36 (i.e., each frame pointer).

Once the dequeuing logic 76 retrieves the frame data for a particular output port based on a fetched frame pointer and stores the frame data in the transmit FIFO, the dequeuing logic 76 checks if the unicopy bit is set to 1. If the unicopy bit is set to 1, the frame pointer is returned to the free buffer queue 64. If the unicopy bit is set to zero indicating a multicopy frame pointer, the dequeuing logic 76 writes the frame pointer with a copy count of minus one (−1) to the multicopy queue 60. The multicopy queue 60 adds the copy count to the entry stored in the multicopy cache 62.

When the copy count in multicopy cache 62 for the frame pointer reaches zero, the frame pointer is passed to the reclaim queue 66. Since a plurality of frame pointers may be used to store a single data frame in multiple buffer memory locations, the frame pointers are referenced to each other to form a linked-list (i.e., chain) of frame pointers to identify the stored data frame in its entirety. The reclaim queue 66 traverses the chain of buffer locations identified by the frame pointers, and passes the frame pointers to the free buffer queue 64.

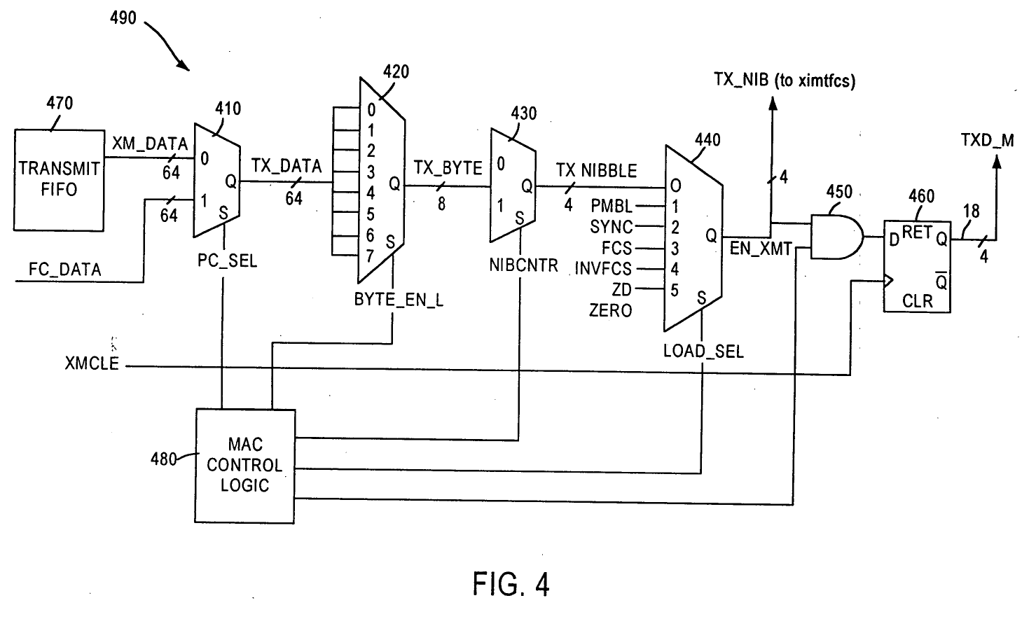

As described earlier, the MAC module 20 transmits data packets from a respective transmit FIFO to the corresponding PHY transceiver 16 via shared RMII 18 according to IEEE 802.3u protocol. FIG. 4 shows an exemplary MAC data path 490, which receives transmit data (TX_DATA) from a transmit FIFO 470 of a MAC 70 (FIG. 3) and transfers it to the RMII 18. Each MAC 70 operates in a free running state and frame data from the respective transmit FIFO 470 is continually output to the MAC data path 490 as the MAC runs through its transmit cycle. More specifically, as the MAC runs through its transmit cycle, the frame data from the respective transmit FIFO is continually output to the MAC data path. At multiplexer 410, 64 bits of data (XM_DATA) from the transmit FIFO are multiplexed with 64 bits of flow control data (FC_DATA) by the signal FC_SEL (Flow Control Select) to provide 64 bits of transmission data (TX_DATA).

Each IMS 12 uses flow control and backpressure to regulate network activity when internal resources deplete to certain user-definable thresholds. Flow control is used on full-duplex ports and backpressure is used on half-duplex ports. Flow control is defined by the IEEE P802.3x standard, as “the generation and reception of MAC Control PAUSE frames that inhibit transmission of data frames for a specified period of time”. Backpressure is defined as the generation of an internal collision on a half-duplex port to terminate frame reception. If flow control is enabled for a port, the MAC will automatically recognize and respond to MAC Control Pause frames received from a link-partner requesting the IMS port to stop transmissions. Also, if flow control is enabled and conditions for asserting flow control is met, the MAC will automatically transmit MAC Control PAUSE frames requesting the link-partner to stop transmissions.

Referring again to FIG. 4, the data stream TX_DATA is multiplexed by mutiplexers 420 and 430 to section the 64 bit words into 4 bit nibbles of data (TX_NIBBLE). The signal LOAD_SEL is used to assemble the final packet; i.e., preamble, Sync, Data, 0's (if Padding or Jamming), followed by FCS (Flow Control Signal). The assembled packet is then output to the RMII via AND gate 450 and flip-flop 460.

EN_XMT (enable transmit signal) is checked only at the beginning of transmission of each frame. If EN_XMT is asserted, the entire frame will be output to the RMII. When EN_XMT is asserted, the data of the frame is transferred to flip-flop 460 which also receives XMCLK (transmit clock signal). Thus, the frame (from the respective transmit FIFO) is output to the MI in response to the XMCLK while EN_XMT is asserted.

There are times when a frame should not be output to the RMII; e.g., when errors are encountered in the frame data. When a frame should not be output to the RMII, EN_XMT is deasserted at the beginning of transmission of the frame and AND gate 450 blocks the frame data from being output onto the RMII. However, even if EX_XMT is deasserted at the beginning of transmission, the frame data will be output from the respective transmit FIFO to the MAC data path in order to free up the transmit FIFO. When this occurs, AND 450 acts as a bit bucket, providing a mechanism to drain the MAC data path in order to provide room for the data of the next frame. Since EN_XMT is checked only at the beginning of transmission of each frame, an entire frame will either be transmitted to the RMII or drained from the MAC data path via the bit bucket.

The present invention provides a mechanism and method for blocking data in a respective transmit FIFO from being output to a network and draining the data from the MAC data path connected to the transmit FIFO.

In this disclosure, there are shown and described only the preferred embodiments of the invention, but it is to be understood that the invention is capable of changes and modifications within the scope of the inventive concept as expressed herein.

1-3. (canceled)

4. A multiport data communication system of claim 1 for switching data packets between ports, the data communication system comprising:
a plurality of ports for receiving and transmitting data packets; and
a memory storing the received data packets, wherein
at least some of the ports include
a transmit queue queuing data packets retrieved from the memory for transmission from the port,
an output terminal outputting the data packets, and
a data path connecting the transmit queue and the output terminal, the data path having a gate controlling transferring of data packets in the data path to the output terminal, and
the data path comprises circuitry configured to:
empty the transmit queue of the data packets,
section the data packets into nibbles of data, and
provide an assembled data packet to the gate.

5. The system of claim 4, wherein
the data packets form a data frame,
the transmit queue is coupled to the data path such that all data packets in each respective transmit queue are transferred to the data path, and
the gate is responsive to an enable signal to selectively either transfer an entire frame on the data path to the output terminal or block transfer of the entire frame to the output terminal.

6. The system of claim 5, wherein the gate is an AND gate that has a first input that receives data packets and a second input that receives the enable signal.

7. The system of claim 4, wherein the circuitry comprises a plurality of multiplexers.

8. (canceled)

9. A method of claim 8 in a communication system of controlling transmission of received data packets from at least one of a plurality of transmit ports comprising:
receiving data packets via a plurality of receive ports;
storing the received data packets in a memory;
reading data from the memory corresponding to each data packet to be transmitted from a respective transmit port and storing in a transmit queue for the respective transmit port;
transferring each data packet from the transmit queue to a data path connected between the transmit queue and an output terminal, and
responsive to assertion and deassertion of an enable signal, transferring and blocking transferring data packets in the data path to the output terminal, wherein
transferring each data packet from the transmit queue empties the transmit queue of the data packets, and
the data path includes circuitry for
sectioning the data packets into nibbles of data, and
providing an assembled data packet.

10-15. (canceled)

16. A bit bucket arrangement in a data communication switch, comprising:
a transmit queue that queues data received at a first port of the switch for transmission from a second port of the switch;
an output terminal coupled to the second port;
a data path coupled between the transmit queue and the output terminal; and
logic coupled to the data path that selectively controls blocking of data from the transmit queue to the output terminal, wherein
the logic selectively controls blocking of data from the transmit queue to the output terminal in responsive to a control signal generated by control logic, and
the data path comprises circuitry configured to:
empty the transmit queue of data,
section the data into nibbles of data, and
provide an assembled data packet to the AND gate.

17. The bit bucket arrangement according to claim 16, wherein the circuitry comprises a plurality of multiplexers.
